(19) United States
(12) Patent Application Publication
(10) Pub. No.: US 2006/0289471 A1
(43) Pub. Date: Dec. 28, 2006

(54) Covering body for heating pipe and heating structure for heating pipe

(75) Inventors: Akira Sasaki, Tokyo (JP); Yoshiyuki Motoyoshi, Tokyo (JP); Tsuyoshi Kobayashi, Tokyo (JP); Kiyoshi Kumasawa, Tokyo (JP); Mitsushi Wadasako, Hamamatsu-shi (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, Tokyo (JP)

(21) Appl. No.: 11/475,256

(22) Filed: Jun. 27, 2006

(30) Foreign Application Priority Data
Jun. 27, 2005 (JP) P.2005-186986

(51) Int. Cl. H05B 3/58

(52) U.S. Cl. 219/535; 138/33

(57) ABSTRACT

The present invention provides a covering body for heating a pipe to be attached to the pipe so as to surround the pipe and to conduct external heat to heat the pipe, the covering body having: a pair of half-cylinder parts each having a halved shape of a cylindrical body along an axial line thereof, the half-cylinder parts each having a cut surface, the cylindrical body having a through hole along an axial line thereof, the pair of the half cylinder parts defining a gap between the cut surfaces upon the covering body being attached to the pipe.

### FIELD OF THE INVENTION

The present invention relates to a covering body for heating a pipe adapted to be mounted on a pipe so that a fluid, such as gas or liquid, is made to flow through the pipe while being heated, and to a heating structure for heating a pipe including the covering body for heating a pipe and a heater.

### BACKGROUND OF THE INVENTION

For example, in a semiconductor manufacturing apparatus or facility, and in a gas pipe such as a ¼″ pipe, a ⅜″ pipe or a ½″ pipe, there can occur a case where a reactive gas or liquid flowing through the inside is condensed and clogging occurs. As countermeasures against that, the pipe is heated and is kept at a specified temperature. Besides, also in order to cause the heated gas or liquid to flow while the high temperature state is kept, the pipe is heated.

The pipe is homogeneously heated (as referred to Reference 1) by mounting a covering body on a pipe, wherein the covering body for heating pipe is constituted by a pair of half-cylinder parts made by halving a cylinder made of a metal such as an aluminum block along the axis of the through hole, and having a through hole at its center to insert a pipe, and by transferring heat from a heater enveloping that covering body for heating a pipe.

[Reference 1] JP-A-2003-185086

In the covering body for heating a pipe, the heat from the heater is transferred to the pipe arranged in the through hole so as to heat the pipe. The contact between the inner wall of the through hole and the peripheral surface of the pipe makes the heat transfer more to enhance the heating efficiency. In the prior art, however, the through hole of the covering body for heating a pipe is formed into a circular in cross-section having a larger diameter than the outer diameter of the pipe. Therefore, depending on the mounted state of the covering body for heating a pipe, the pipe may fail to contact at its portion with the inner wall of the through hole thereby to cause heating irregularities.

### SUMMARY OF THE INVENTION

The present invention has been conceived in view of the above situations, and has an object to provide a covering body for heating a pipe, which does not have the heating irregularities by holding the peripheral surface of the pipe and the inner wall of the through hole in reliable contact.

The present inventors have made eager investigation to examine the problem. As a result, it has been found that the foregoing objects can be achieved by the following covering bodies and covering structures. With this finding, the present invention is accomplished.

The present invention is mainly directed to the following items:

1. A covering body for heating a pipe to be attached to the pipe so as to surround the pipe and to conduct external heat to heat the pipe, the covering body comprising: a pair of half-cylinder parts each having a halved shape of a cylindrical body along an axial line thereof, the half-cylinder parts each having a cut surface, the cylindrical body having a through hole along an axial line thereof, the pair of the half cylinder parts defining a gap between the cut surfaces upon the covering body being attached to the pipe.

2. The covering body for heating a pipe according to item 1, wherein the pair of the half-cylinder parts and the gap define a thorough hole for inserting the pipe, a sectional shape of the through hole is one of: a circular shape; an annular shape comprising a curved line having a curvature radius larger than the radius of the peripheral surface of the pipe; an elliptical shape; and a square shape.

3. The covering body for heating a pipe according to item 1, wherein at least one of the half-cylinder parts comprises portions each having a divided shape of the half-cylinder part along an axial line thereof

4. A heating structure for heating a pipe, comprising: a covering body for heating a pipe according to item 1; and a heater arranged around the covering body.

5. A covering body for heating a pipe to be attached to the pipe so as to surround the pipe and to conduct external heat to heat the pipe, the covering body comprising: a pair of half-cylinder parts each having a halved shape of a cylindrical body along an axial line thereof, the half-cylinder parts each having a cut surface, the cylindrical body having a through hole along an axial line thereof, the cut surfaces abutting each other to define a through hole for inserting pipe upon the covering body being attached to the pipe, a sectional shape of the through hole being one of: an annular shape comprising a curved line having a curvature radius larger than the radius of the peripheral surface of the pipe, a maximum distance between a surface including the abutted cut surfaces and a point on the curved line is equal to the radius of the peripheral surface of the pipe; an elliptical shape having the minor axis having a length equal to the diameter of the peripheral surface of the pipe; and a square shape having a side equal to the diameter of the peripheral surface of the pipe.

6. The covering body for heating a pipe according to item 4, wherein at least one of the half-cylinder parts comprises portions each having a divided shape of the half-cylinder part along an axial line thereof

7. A heating structure for heating a pipe, comprising: a covering body for heating a pipe according to item 5; and a heater arranged around the covering body.

In the invention, the inner wall of the through hole is formed into a curved face having a specific sectional shape so that the peripheral surface of the pipe and the inner wall of the through hole can make reliable line contact in the longitudinal direction of the pipe. As a result, the heating irregularities care eliminated to enhance the heating efficiency.

### BRIEF DESCRIPTION OF THE DRAWINGS

FIG. 1 is a perspective view showing the assembled state of a covering body for heating a pipe according to the invention.

FIG. 2 is a front elevation of the covering body for heating a pipe shown in FIG. 1, and shows an example, in which a gap is formed between the cut faces of half-cylinder parts and in which a through hole is formed into a section of a pupil shape.

FIG. 3 is a front elevation of the covering body for heating a pipe shown in FIG. 1, and shows an example, in which the gap is formed between the cut faces of half-cylinder parts and in which the through hole is formed into an elliptical section.

FIG. 4 is a front elevation of the covering body for heating a pipe shown in FIG. 1, and shows an example, in which the gap is formed between the cut faces of half-cylinder parts and in which the through hole is formed into a square section.

FIG. 5 is a front elevation of the covering body for heating a pipe shown in FIG. 1, and shows an example, in which the cut faces of half-cylinder parts abut each other and in which the through hole is formed into a section of a pupil shape.

FIG. 6 is a front elevation of the covering body for heating a pipe shown in FIG. 1, and shows an example, in which the cut faces of half-cylinder parts abut each other and in which the through hole is formed into an elliptical section.

FIG. 7 is a front elevation of the covering body for heating a pipe shown in FIG. 1, and shows an example, in which the cut faces of half-cylinder parts abut each other and in which the through hole is formed into a square section.

FIG. 8 is an exploded perspective view showing one example of a mantle heater.

FIG. 9A is an enlarged section showing one example of members constituting the mantle heater, and FIG. 9B an enlarged section showing a second example of the same.

The reference numerals used in the drawings denote the followings,
1 Pipe
10 Covering body for heating a pipe
14 Holding Member
16 Half-Cylinder Part
17 Half-Cylinder Part
22 Through Hole
22a Inner Wall
100 Inner Layer Member
110 Mantle Heater
200 Outer Layer Member
300 Heating Element
302 Heating Wire
303 Inorganic Fiber Sheet
400 Non-/Un-Inflammable Fiber Sheet

### DESCRIPTION OF EXEMPLARY EMBODIMENTS

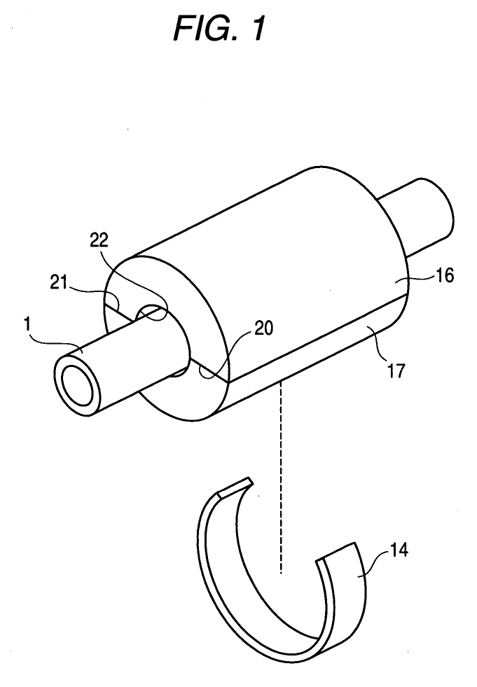

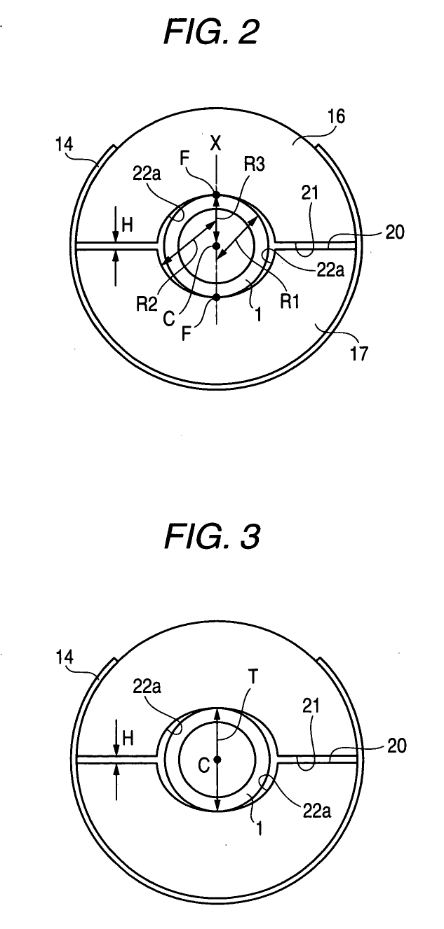

A preferred mode of embodiment according to the invention will be described in detail with reference to the accompanying drawings. FIG. 1 is a perspective view showing the assembled state of a covering body for heating a pipe according to the invention, and FIG. 2 is a front elevation of FIG. 1.

As shown, a covering body for heating a pipe 10 is made of an aluminum alloy, for example, and is constituted to have half-cylinder parts 16 and 17, which are formed by cutting such a cylindrical block along an axis C into halves as has a pipe inserting through hole 22 along the axis C. Here, the cylinder block should not be limited to the cylinder, as shown, but may be suitably modified into a square cylinder or a cylinder having a polygonal section. Moreover, the two half-cylinder parts 16 and 17 are so mounted on a pipe 1 that their planar cut faces 20 and 21 confront each other, thereby to define the through hole 22 with their inner walls 22a and 22a. In order to keep this mounted state, moreover, a holding member 14 is mounted on the peripheral surface of the two half-cylinder parts 16 and 17. The holding member 14 can be made of an arcuate spring steel sheet or a belt of a metal or heat-resisting resin, as shown, but should not be limited thereto. Here, the pipe 1 is a pipe made of a heat and corrosion resisting material such as a stainless steel sheet.

In the invention, as shown in FIG. 2, the half-cylinder parts 16 and 17 are so specified individually in the arcuate lengths of their peripheral surfaces and in the arcuate lengths of their inner walls 22a and 22a that the confronting cut faces 20 and 21 may form a gap H therebetween when they are mounted on the pipe 1. The formation of the gap H implies that the inner walls 22a and 22a of the two half-cylinder parts 16 and 17 each contact at least partially with the peripheral surface of the pipe 1, so that the heat from the outside is efficiently transferred to the pipe 1. Although not especially restricted, the larger gap H can release the more heat. For the general gas piping of a ¼ inch pipe, a ⅜ inch pipe or ½ inch pipe in a semiconductor manufacturing apparatus, for example, the gap H is preferred to be 0.25 to 1.0 mm and more preferred to be 0.25 to 0.5 mm.

Moreover, the inner walls 22a of the half-cylinder parts 16 and 17 have such arcuate sectional shapes as are made of larger radii of curvature R1 and R2 than that of the radius R3 of the peripheral surface of the pipe 1. Moreover, the centers of curvature of the radii of curvatures R1 and R2 are located on a virtual line X, which is perpendicular, at the center point C corresponding to the axis of the through hole 22, to the line joining the two cut faces 20 and 21. As a result, the through hole 22 has a section generally of a pupil shape thereby to ensure a line contact between the peripheral surface of the pipe 1 and the inner walls 22a of the through hole 22 at the deepest points F of the inner walls 22a in the longitudinal direction of the pipe 1. Therefore, the heat from the heater can be reliably and efficiently transferred to the pipe 1 through the half-cylinder parts 16 and 17.

Here, as the radii of curvature R1 and R2 becomes the larger for the radius R3 of the peripheral surface of the pipe 1, the width of the through hole 22 (i.e., the portion between the cut faces 20 and 21) becomes the larger so that the gap between the peripheral surface of the pipe 1 and the through hole 22 is enlarged to increase the heat radiation from the pipe 1. It is, therefore, preferred that the radii of curvature R1 and R2 are adjusted to make the gap as small as possible. Specifically, the radii of curvature R1 and R2 are preferred to be 1.008 to 1.315 times as large as the radius R3 of the peripheral surface of the pipe 1.

Moreover, although not shown, the through hole 22 may also be formed into a section generally of a pupil shape but turned by 90 degrees so that the virtual line X may be contained in the cut faces 20 and 21.

As shown in FIG. 3, the inner walls 22a of the half-cylinder parts 16 and 17 can also be formed so that the sectional shape of the through hole 22 may become an ellipse around the center point C. In this case, a length of the miner axis T of the ellipse is so set to the outer diameter of the pipe 1 that the gap H may be formed between the cut faces 20 and 21 of the half-cylinder parts 16 and 17. Like the aforementioned shape, the ellipse is preferred to have a small difference between the lengths of major axis and minor axis (i.e., the length between the two cut faces 20 and 21) like the circle so as to suppress the heat radiation. With this elliptical through hole 22, the portion of the inner walls 22a corresponding to the miner axis and the peripheral surface of the pipe 1 make the reliable contact.

Here, this elliptical shape can also be turned by 90 degrees so that the miner axis T may be contained in the cut faces 20 and 21, although not shown.

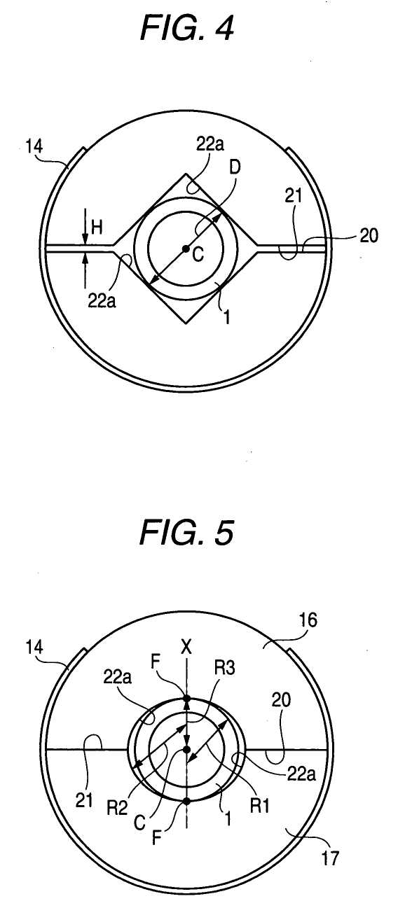

As shown in FIG. 4, moreover, the inner walls 22a of the half-cylinder parts 16 and 17 can also be formed into a V-groove of a rectangular equilateral triangle so that the through hole 22 may have a shape of a square section. In this case, the depth of the V-groove is set to the outer diameter D of the pipe 1 so that the gap H may be formed between the cut faces 20 and 21 of the half-cylinder parts 16 and 17. With this V-shape, the peripheral surface of the pipe 1 makes reliable contact with the four sides of the half-cylinder parts 16 and 17, so that the contact portions with the peripheral surface of the pipe 1 are doubled from that of the aforementioned pupil-shaped through hole or elliptical through hole thereby to take an advantage in the heat transfer efficiency. Here, the V-groove may be an equilateral triangle other than the rectangular one, but the volume of the four corners having no contact with the peripheral surface of the pipe 1 undesirably increases.

Although not show, moreover, the inner walls 22a of the half-cylinder parts 16 and 17 may also be formed into an arcuate shape slightly shorter than a semicircle so that the through hole 22 may have a circular sectional shape. The radius of the arcs is preferred to be equal to the outer diameter of the pipe 1 but may be larger.

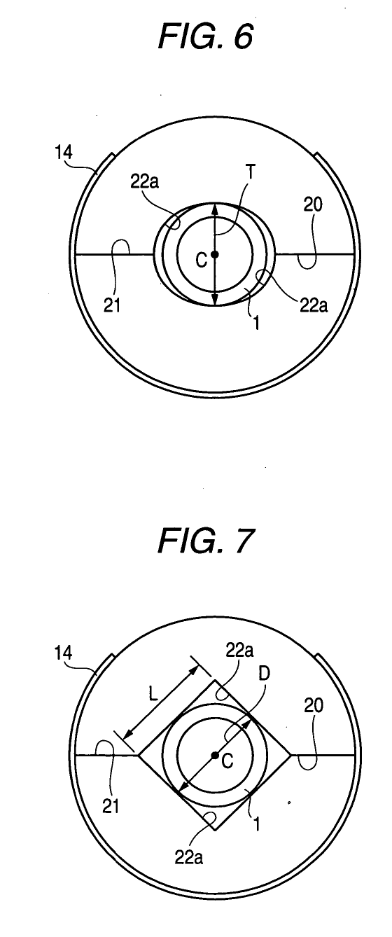

In the modes thus far described, the gap H is formed between the cut faces 20 and 21 of the half-cylinder parts 16 and 17, but the mode can be modified such that the two cut faces 20 and 21 abut each other, as shown in FIG. 5 to FIG. 7.

The mode shown in FIG. 5 corresponds to the pupil-shaped section shown in FIG. 2. However, the deepest points F of the inner walls 22a are set to coincide with the radius R3 of the peripheral surface of the pipe 1.

On the other hand, the mode shown in FIG. 6 corresponds to the elliptical section shown in FIG. 3. In this mode, however, the length of the miner axis T is set to be equal to the diameter D of the peripheral surface of the pipe 1.

On the other hand, the mode shown in FIG. 7 corresponds to the square section shown in FIG. 4. In this mode, however, the length (L) of the sides is set to be equal to the diameter D of the peripheral surface of the pipe 1.

Although not shown, moreover, any of the aforementioned half-cylinder parts 16 and 17 can be divided in the axial direction into a plurality so that the divided ones may be jointed to form one half-cylinder part.

In the through hole having the circular section of the prior art, the pipe is frequently offset, even in case its peripheral surface and the through hole contact, toward one half-cylinder part thereby to make the line contact exclusively with the inner wall of that one half-cylinder part. According to the invention, on the contrary, the peripheral surface of the pipe 1 reliably makes the line contact with the two inner walls 22a of the half-cylinder parts 16 and 17 so that the contact portions are at least doubled to eliminate the heating irregularity and to enhance the heating efficiency.

Moreover, the invention provides a pipe heating structure including the aforementioned covering body for heating a pipe, and the heater arranged to enclose the covering body for heating a pipe. No restriction is made on the heater, but a sheet- or mat-shaped heater may be wound on the covering body for heating a pipe, or a cylindrical heater may be mounted. A preferred heater is exemplified in the following by the mantle heater, which is disclosed in JP-A-2002-295783 by the present applicant.

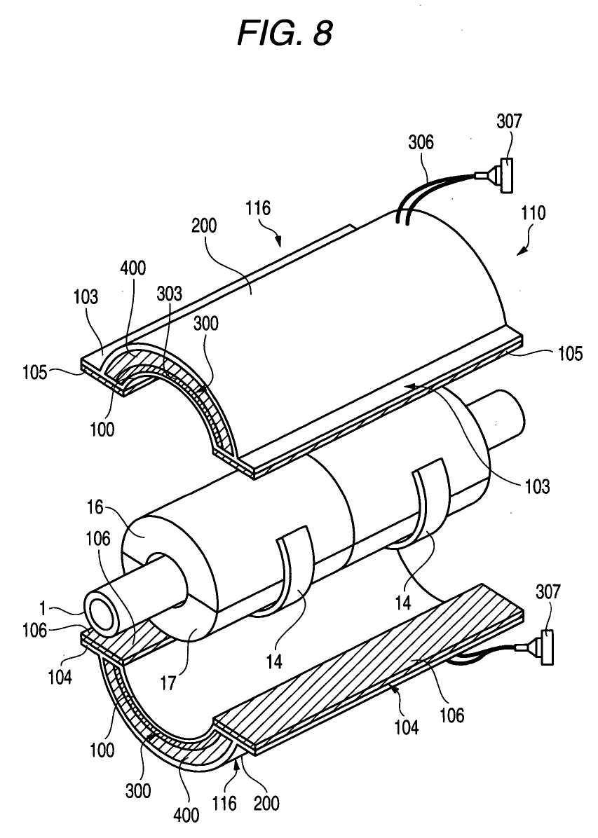

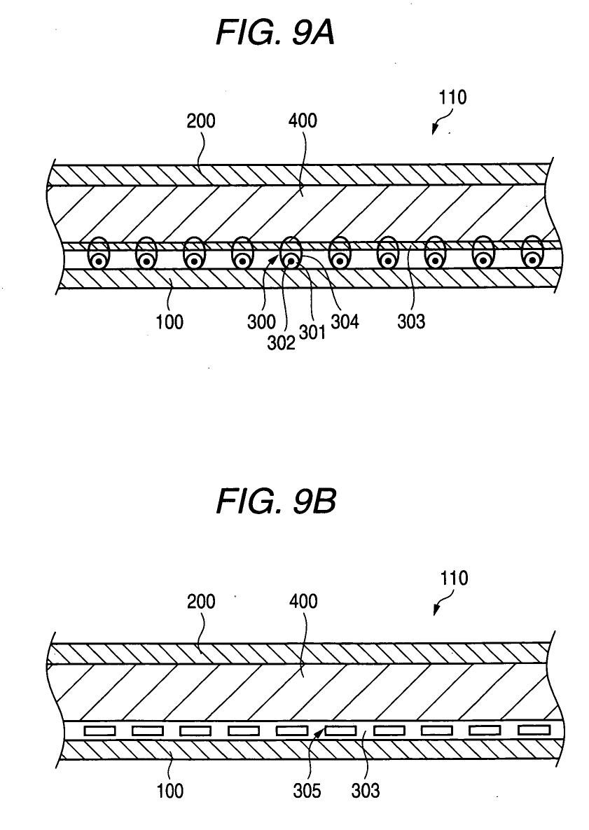

As shown in FIG. 8, a mantle heater 110 is constituted of two half-cylinder parts 116 and 116, in which the aforementioned covering body for heating a pipe is arranged. As shown in FIG. 9A, the covering body for heating a pipe has a sectional structure, in which an inorganic fiber sheet 303 having a heating element 300 and a non-/un-inflammable fiber sheet 400 are sandwiched between an inner layer member 100 and an outer layer member 200 such that they are laminated either integrally or merely one over the other.

Specifically, the inner layer member 100 and the outer layer member 200 may be preferably made of fluoroplastics such as PTFE (polytetrafluoroethylene), PFT (tetrafluoroethylene-per-fluoroalkoxyethylene copolymer) or FEP (tetrafluoroethylene-hexafluoropropylene copolymer), or can be made of PCTFE (polychlorotrifluoroethylene), ETFE (ethylene-tetrafluoroethylene copolymer), ETFE (tetrafluoroethylene-ethylene copolymer), ECTFE (chlorotrifluoroethylene-ethylene copolymer) or PVDF (polyvinylidene fluoride).

Moreover, the inner layer member 100 and the outer layer member 200 can also be made of, in addition to the aforementioned materials, a thermo-flexible resin such as polyamide, polycarbonate, polyacetal, polybutylene terephthalate, modified polyphenyleneether, polyphenylenesulfide, polysulfone, polyethersulfone, polyarylate, polyetheretherketone, polyphthamide, polyimide, polyetherimide or polymethylpenten.

The heating element 300 to be employed can be prepared by stitching a heating wire 302 insulated and sheathed by a thermal insulation cloth 301 to glass cloth of an inorganic fiber sheet 303 by means of dewing thread 304, as shown in FIG. 9A, or by preparing a sheet heater 305 into a predetermined shape to have a predetermined capacity, as shown in FIG. 9B. Moreover, a power connecting connector 307 is attached to the heating wire 302 through lead wires 306. Here, the heating element 300 may also be attached to the following non-/un-inflammable fiber sheet 400.

This non-/un-inflammable fiber sheet 400 to be employed can be exemplified by an inorganic fiber sheet or an organic fiber sheet, the former which is preferably prepared by kneading an inorganic fiber material such as glass fiber, ceramic fiber or silica fiber and by forming the inorganic fiber material into a sheet shape with an inorganic binder such as colloidal silica, alumina sol or silicate of soda. There can also be employed an organic fiber sheet such as aramid, polyamide or polyimide.

Moreover, the mantle heater 110 is fixed, while sheathing the covering body for heating a pipe, by bringing the individual joint portions 103 and 104 of the two half-cylinder parts 116 and 116 into abutment against each other through magic tapes (known under the trade mark) 105 and 106. Moreover, the known fixing means such as fixtures such as hooks or buckles, or belts can also be adopted as the fixing means.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2005-186986 filed on Jun. 27, 2005, and the contents thereof are incorporated herein by reference.

What is claimed is:

1. A covering body for heating a pipe to be attached to the pipe so as to surround the pipe and to conduct external heat to heat the pipe, the covering body comprising a pair of half-cylinder parts each having a halved shape of a cylindrical body along an axial line thereof, the half-cylinder parts each having a cut surface, the cylindrical body having a through hole along an axial line thereof,
the pair of the half cylinder parts defining a gap between the cut surfaces upon the covering body being attached to the pipe.

2. The covering body for heating a pipe according to claim 1,
wherein the pair of the half-cylinder parts and the gap define a thorough hole for inserting the pipe, and a sectional shape of the through hole is one of:
a circular shape;
an annular shape comprising a curved line having a curvature radius larger than the radius of the peripheral surface of the pipe;
an elliptical shape; and
a square shape.

3. The covering body for heating a pipe according to claim 1,
wherein at least one of the half-cylinder parts comprises portions each having a divided shape of the half-cylinder part along an axial line thereof.

4. A heating structure for heating a pipe, comprising:
a covering body for heating a pipe according to claim 1; and
a heater arranged around the covering body.

5. A covering body for heating a pipe to be attached to the pipe so as to surround the pipe and to conduct external heat to heat the pipe, the covering body comprising a pair of half-cylinder parts each having a halved shape of a cylindrical body along an axial line thereof, the half-cylinder parts each having a cut surface, the cylindrical body having a through hole along an axial line thereof,
the cut surfaces abutting each other to define a through hole for inserting pipe upon the covering body being attached to the pipe,
a sectional shape of the through hole being one of:
an annular shape comprising a curved line having a curvature radius larger than the radius of the peripheral surface of the pipe, a maximum distance between a surface including the abutted cut surfaces and a point on the curved line is equal to the radius of the peripheral surface of the pipe;
an elliptical shape having the minor axis having a length equal to the diameter of the peripheral surface of the pipe; and
a square shape having a side equal to the diameter of the peripheral surface of the pipe.

6. The covering body for heating a pipe according to claim 4,
wherein at least one of the half-cylinder parts comprises portions each having a divided shape of the half-cylinder part along an axial line thereof.

7. A heating structure for heating a pipe, comprising:
a covering body for heating a pipe according to claim 5; and
a heater arranged around the covering body.
